(19) United States
(12) Patent Application Publication
(10) Pub. No.: US 2024/0045782 A1
(43) Pub. Date: Feb. 8, 2024

(54) Suggesting a New and Easier System Function by Detecting User's Action Sequences

(71) Applicant: QUALCOMM Incorporated, San Diego, CA (US)

(72) Inventors: Sungrack YUN, Seongnam (KR); Hyoungwoo PARK, Seoul (KR); Seunghan YANG, Incheon (KR); Hyesu LIM, Seongnam-si (KR); Taekyung KIM, Seoul (KR); Jaewon CHOI, Seoul (KR); Kyu Woong HWANG, Daejeon (KR)

(21) Appl. No.: 17/818,064

(22) Filed: Aug. 8, 2022

(51) Int. Cl. G06F 11/34

(52) U.S. Cl. CPC G06F 11/3438; G06F 2201/81

(57) ABSTRACT

Embodiments include methods performed by a processor of a computing device for suggesting more efficient action sequences to a user. The methods may include recognizing a user action sequence including one or more user actions performed by the user to achieve a result, determining a first difficulty rating of the user action sequence, determining whether a cluster of multiple system action sequences exists within a cluster database in which each system action sequence of the one or more system action sequences produces the result. Methods may further include comparing the first difficulty rating to one or more difficulty ratings of the one or more system action sequences in response to determining that the cluster of multiple system action sequences exists within the cluster database, and displaying, via a display interface of the computing device, one or more system action sequences with a lower difficulty rating than the first difficulty rating.

### BACKGROUND

User equipment and consumer devices have become increasingly complex, offering advanced and an increased number of features that may be implemented by a user to perform various operations. Often, these more complex and intelligent features go unutilized by an operating user, who instead may perform a task through outdated, less efficient, and/or more time-consuming steps. Thus, a user who is not aware of more advanced, simplified, or efficient features that are able to be implemented on a device may waste time and computational resources by implementing less efficient processes to achieve the same result. Furthermore, a user may be performing difficult tasks to achieve a result that could otherwise be obtained using a less difficult process, therefore deteriorating the user experience.

### SUMMARY

Various aspects include methods performed by a processor of a computing device for suggesting more efficient action sequences to a user. Various aspect methods may include recognizing a user action sequence including one or more user actions performed by the user to achieve a result, determining a first difficulty rating of the user action sequence, determining whether a cluster of multiple system action sequences exists within a cluster database, in which each system action sequence of the one or more system action sequences produces the result, comparing the first difficulty rating to one or more difficulty ratings of the one or more system action sequences in response to determining that the cluster of multiple system action sequences exists within the cluster database, and displaying, via a display interface of the computing device, one or more system action sequences with a lower difficulty rating than the first difficulty rating.

Some aspects may further include generating a new cluster including the user action sequence in response to determining that a cluster of multiple system action sequences that produce the result does not exist within the cluster database. Some aspects may further include determining whether a system action sequence of the one or more system action sequences may include the one or more user actions of the user action sequence in response to determining that the cluster of multiple system action sequences exists within the cluster database, and updating the cluster database with the user action sequence in response to determining that a system action sequence of the one or more system action sequences does not include the one or more user actions of the user action sequence.

In some aspects, comparing the first difficulty rating to one or more difficulty ratings of the one or more system action sequences may include determining whether the user action sequence has fewer actions than the one or more system action sequences, and displaying, via the display interface of the computing device, the one or more system action sequences with a lower difficulty rating than the first difficulty rating may include displaying the one or more system action sequences with a lower difficulty rating than the first difficulty rating in response to determining that the user action sequence has fewer actions than the one or more system action sequences.

In some aspects, comparing the first difficulty rating to one or more difficulty ratings of the one or more system action sequences may include determining whether the user action sequence is executed slower than a time to perform any of the one or more system action sequences, and displaying, via the display interface of the computing device, the one or more system action sequences with a lower difficulty rating than the first difficulty rating may include displaying the one or more system action sequences with a lower difficulty rating than the first difficulty rating in response to determining that the user action sequence is executed slower than the time to perform any of the one or more system action sequences.

Some aspects may further include determining whether the user action sequence has been performed a threshold number of times, in which comparing the first difficulty rating to one or more difficulty ratings of the one or more system action sequences is performed in response to determining that the user action sequence has been performed a threshold number of times.

Some aspects may further include receiving a user selection indicating that the user action sequence is preferred by the user over the displayed one or more system action sequences with a lower difficulty rating, and updating the cluster database by storing the user action sequence with a lower difficulty rating than the one or more difficulty ratings of the displayed one or more system action sequences.

In some aspects, updating the cluster database by storing the user action sequence with a lower difficulty rating than the one or more difficulty ratings of the displayed one or more system action sequences may include changing the first difficulty rating to a lower difficulty rating. In some aspects, updating the cluster database by storing the user action sequence with a lower difficulty rating than the one or more difficulty ratings of the displayed one or more system action sequences may include changing the one or more difficulty ratings of the displayed one or more system action sequences to be lower than the first difficulty rating. In some aspects, the user action sequence may include context and environment information associated with each action of the one or more user actions.

Further aspects include a computing device having a processor configured to perform one or more operations of any of the methods summarized above. Further aspects include a computing device having means for performing functions of any of the methods summarized above. Further aspects include a non-transitory processor-readable storage medium having stored thereon processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating an example computing device suitable for implementing any of the various embodiments.

FIG. 2 is a component block diagram illustrating a software architecture including a radio protocol stack for the user and control planes in wireless communications suitable for implementing any of the various embodiments.

FIG. 3 is a component block diagram illustrating an example system configured to suggest a more efficient action sequence to a user for achieving a result according to some embodiments.

FIG. 4 is a block diagram illustrating example data structures for suggesting a more efficient action sequence to a user of a computing device for achieving a result according to some embodiments.

FIG. 5 is a block diagram illustrating an example updated data structure for suggesting a more efficient action sequence to a user of a computing device for achieving a result according to some embodiments.

FIG. 6 is a process flow diagram of a method for suggesting a more efficient action sequence to a user of a computing device for achieving a result according to some embodiments.

FIG. 7A is a process flow diagram of an example method that may be performed by a processor of a computing device for suggesting a more efficient action sequence to a user for achieving a result in accordance with various embodiments.

FIGS. 7B-7E are process flow diagrams of example operations that may be performed as part of the method illustrated in FIG. 7 as described for suggesting a more efficient action sequence to a user for achieving a result in accordance with some embodiments.

FIG. 8 is a component block diagram illustrating an example computing device suitable for use with the various embodiments.

FIG. 9 is a component block diagram illustrating an example server suitable for use with the various embodiments.

FIG. 10 is a component block diagram illustrating an example wireless communication device suitable for use with the various embodiments.

FIG. 11 illustrates an example wearable computing device in the form of a smart watch according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Many different user equipment (UEs) and consumer and/or commercial computing devices, such as smartphones, eXtended/augmented/mixed reality (XR, AR, MR) devices, personal computers, home appliances (e.g., smart televisions, smart refrigerators, automated vacuum systems, air conditioning control units), automotive dashboard interfaces, multimedia displays, vending operations and display interfaces (e.g., point-of-sale systems), or any other device with an interactive display interface and/or operable controls may include a vast number of features that may be implemented by a user to perform various tasks. Such features may allow a user to perform a task in fewer actions, in a shorter amount of time, and/or with an easier user experience as compared to a set of actions that a user typically takes to perform the same task. However, these features often go overlooked by a user, as a user may not be aware of these features or may have forgotten the features.

Various embodiments include methods and processors of a computing device for suggesting a more efficient (i.e., simplified/fewer steps, less time, less user effort) and/or easier (i.e., in terms of user experience/quality of experience (QoE)) action sequence to a user for achieving a certain result. Various embodiments include a processor of a computing device (e.g., mobile phone, wearable device, home appliance user interface, etc.) configured to record a series, or sequence, of user actions taken by a user to perform a task. The processor of the computing device may be configured to determine whether a more efficient sequence of actions exists that the user may implement to achieve the same result as the user actions. If so, the processor may present the user with the more efficient action sequence, thereby introducing or reminding the user of the more efficient action sequence which the user may use to achieve the same result the next time.

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a computing device and/or subscription on a computing device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA), IEEE 802.11 (WiFi), IEEE 802.16 (WiMAX), IEEE 802.20, Flash-OFDM®, etc. Reference may be made to wireless networks that use Long Term Evolution (LTE) standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in various embodiments.

Recently, with the rapid development and advances of technologies, a computing device may include a number of functions and intelligent features. It may be difficult for a user to be aware of and utilize one or more of these advanced features, especially useful and effective features at a certain, most beneficial moment during operation of a computing device. For example, a user may only know or use basic functions/features that were available on a previous model or operating system of a computing device, and may perform tasks on a computing device using methods that are familiar. A user may further be unaware of more efficient and/or easier to use features as many commercial consumers find it difficult or tedious to read a system manual, let alone remember all the features documented within a system manual. A user may also encounter difficulty in recalling more efficient intelligent features at a precise moment during operation of a computing device, such that a user may be attempting to perform a task that is time sensitive. Performing some tasks may be complicated or frustrating for a user (e.g., thumbprint verification when both hands are preoccupied), but the user may not be aware that the same task can be performed using some other method (e.g., such as iris verification). Thus, the user may have a negative user experience when other available interaction sequences not known to the user may have yielded the same result and provided the user with a positive experience.

Various embodiments may provide a user with recommended or suggested action sequences as alternatives to achieve a same result as an action sequence recently or contemporaneously being performed by a user. The suggested action sequences may notify a user of a more efficient (i.e., less time-consuming, fewer actions, easier-to-perform actions) action or action sequence that the user may implement to achieve a desired result. For example, a user may not be aware that facial recognition software used to unlock a mobile device can unlock the device while the user is wearing a protective mask, such as through iris recognition, and may take the mask off every time the user attempts to unlock the device. After recognizing that the user takes the mask off to unlock the phone, the mobile device may provide a message to the user notifying the user that the mask may not need to be removed, and/or that the mobile device may be unlocked via positioning a smart watch proximate to the mobile device. As another example, a user may manually set turn on or off a dark theme/power-save/low-light mode of a computing device throughout the day, such as turning on the dark theme in the evening and turning it off again in the morning. The computing device may detect this user's pattern and suggest a new feature, such as presenting the user with a series of action (i.e., through a tutorial or list of steps) to configure the computing device to automatically schedule the dark theme based on the sun set and/or sun rise time.

Various embodiments include methods and device for providing a user with a more efficient and/or easier-to-implement action sequence to achieve a same result as compared to an action sequence that a user implements or has repeatedly implemented. By notifying the user of available advanced features, computational resources may be reserved, battery life may be extended, and user experience may be increased when a user opts to performs the suggested action sequence instead of the action sequence(s) previously and inefficiently used.

Various embodiments include methods performed by a processor of a computing device for suggesting more efficient action sequences to a user for achieving the same or similar results. Various embodiments may include monitoring user interactions with the computing device to recognize when a user action sequence including one or more user actions is performed by the user to achieve a result, determining a first difficulty rating of the user action sequence, determining whether a cluster of multiple system action sequences exists within a cluster database, in which each action sequence of the multiple alternative user action sequences produces the same result. The method may further include comparing the first difficulty rating to one or more difficulty ratings of each of the multiple alternative user action sequences in response to determining that the cluster of multiple alternative system action sequences that produce the same result exists within the cluster database, and displaying, via a display interface of the computing device, one or more alternative system action sequences with a lower difficulty rating than the first difficulty rating.

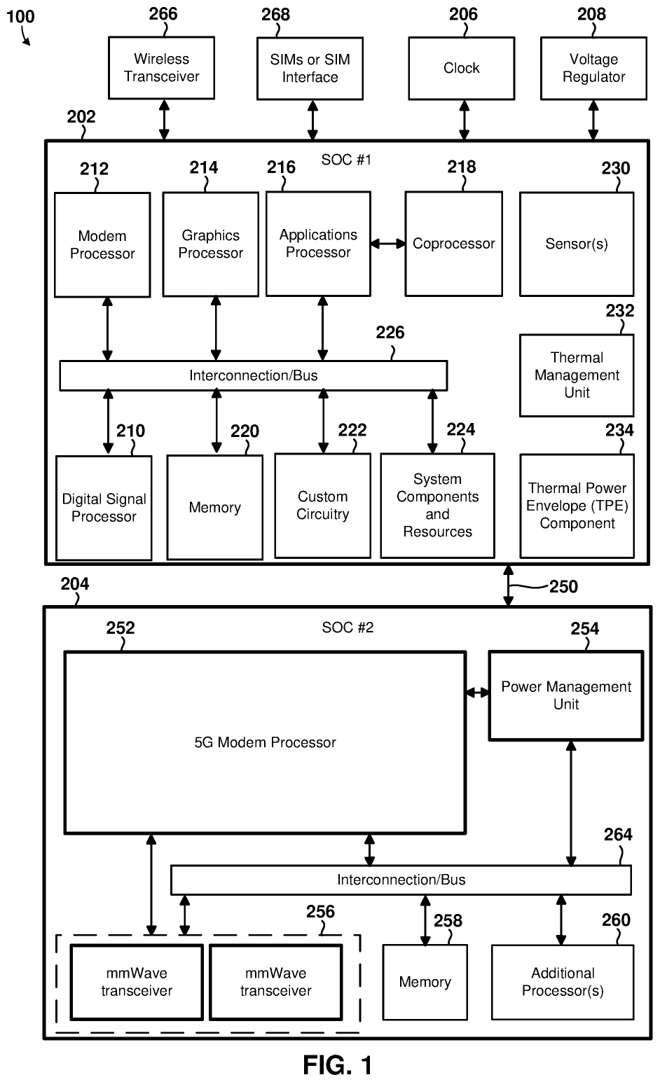

FIG. 1 is a component block diagram illustrating an example computing device 100 suitable for implementing any of the various embodiments. Various embodiments may be implemented on a number of single processor and multiprocessor computer systems, including a system-on-chip (SoC) or system in a package.

With reference to FIG. 1, the illustrated example computing device 100 (which may be a system-in-a-package in some embodiments) includes a two SoCs 202, 204 coupled to a clock 206, a voltage regulator 208, at least one subscriber identity module (SIM) 268 and/or a SIM interface and a wireless transceiver 266 configured to send and receive wireless communications via an antenna (not shown) to/from network computing devices, such as a base station. In some embodiments, the first SoC 202 operate as central processing unit (CPU) of the computing device that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuitry 222, system components and resources 224, an interconnection/bus module 226, one or more sensors 230 (e.g., accelerometer, temperature sensor, pressure sensor, optical sensor, infrared sensor, analog sound sensor, etc.), a thermal management unit 232, and a thermal power envelope (TPE) component 234. The second SoC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second SoC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266, and at least one SIM 268 and/or SIM interface (i.e., an interface for receiving one or more SIM cards). Resources external to the SoC (e.g., clock 206, voltage regulator 208) may be shared by two or more of the internal SoC processors/cores. The at least one SIM 268 (or one or more SIM cards coupled to one or more SIM interfaces) may store information supporting multiple subscriptions, including a first 5GNR subscription and a second 5GNR subscription, etc.

In addition to the example computing device 100 discussed above, various embodiments may be implemented in a wide variety of computing systems, which may include a single processor, multiple processors, multicore processors, or any combination thereof.

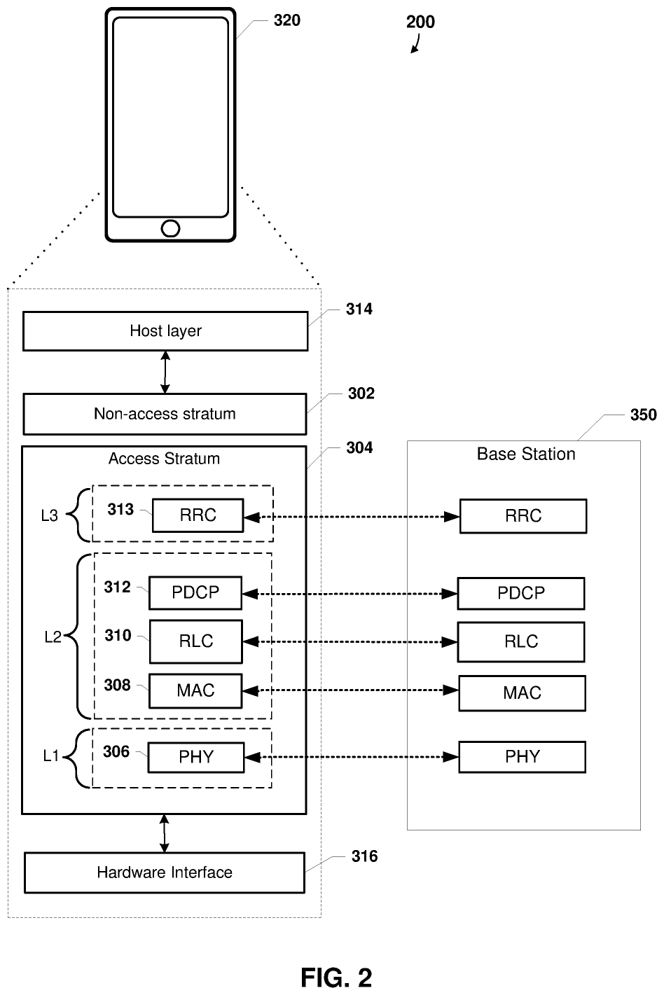

FIG. 2 is a component block diagram illustrating a software architecture 300 including a radio protocol stack for the user and control planes in wireless communications suitable for implementing any of the various embodiments. With reference to FIGS. 1-2, the computing device 320 may implement the software architecture 200 to facilitate communication between a computing device 320 (e.g., the computing device 100) and the base station 350 of a telecommunication system. In some embodiments, layers in software architecture 200 may form logical connections with corresponding layers in software of the base station 350. The software architecture 200 may be distributed among one or more processors (e.g., the processors 212, 214, 216, 218, 252, 260). While illustrated with respect to one radio protocol stack, in a multi-SIM (subscriber identity module) computing device, the software architecture 200 may include multiple protocol stacks, each of which may be associated with a different SIM (e.g., two protocol stacks associated with two SIMs, respectively, in a dual-SIM wireless communication device). While described below with reference to LTE communication layers, the software architecture 200 may support any of variety of standards and protocols for wireless communications, and/or may include additional protocol stacks that support any of variety of standards and protocols wireless communications.

The software architecture 200 may include a Non-Access Stratum (NAS) 302 and an Access Stratum (AS) 304. The NAS 302 may include functions and protocols to support Packet filtering, security management, mobility control, session management, and traffic and signaling between a SIM(s) of the computing device and its core network. The AS 304 may include functions and protocols that support communication between a SIM(s) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The PHY layer 306 may include various logical channels, including the Physical Downlink Control Channel (PDCCH) and the Physical Downlink Shared Channel (PDSCH). As an example, the PHY layer 306 may support Channel State Information (CSI) measurements and reporting (e.g., Channel Quality Indicator (CQI) measurements and reporting).

In the user and control planes, Layer 2 (L2) of the AS 304 may be responsible for the link between the computing device 320 and the base station 350 over the physical layer 306. In the various embodiments, Layer 2 may include a Media Access Control (MAC) sublayer 308, a Radio link Control (RLC) sublayer 310, and a Packet data convergence protocol (PDCP) 312 sublayer, each of which form logical connections terminating at the base station 350.

In the control plane, Layer 3 (L3) of the AS 304 may include a Radio Resource Control (RRC) sublayer 3. While not shown, the software architecture 200 may include additional Layer 3 sublayers, as well as various upper layers above Layer 3. In various embodiments, the RRC sublayer 313 may provide functions including broadcasting system information, paging, and establishing and releasing an RRC signaling connection between the computing device 320 and the base station 350.

In various embodiments, the PDCP sublayer 312 may provide uplink functions including multiplexing between different Radio bearers and logical channels, sequence number addition, handover data handling, integrity protection, ciphering, and header compression. In the downlink, the PDCP sublayer 312 may provide functions that include in-sequence delivery of data packets, duplicate data Packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 200 may provide functions to transmit data through physical media, the software architecture 200 may further include at least one host layer 314 to provide data transfer services to various applications in the computing device 320. In some embodiments, application-specific functions provided by the at least one host layer 314 may provide an interface between the software architecture and the general-purpose processor.

In other embodiments, the software architecture 200 may include one or more higher logical layer (e.g., transport, session, presentation, application, etc.) that provide host layer functions. In some embodiments, the software architecture 200 may include an application layer in which a logical connection terminates at another device (e.g., end user device, server, etc.). In some embodiments, the software architecture 200 may further include in the AS 304 a hardware interface 316 between the physical layer 306 and the communication hardware (e.g., one or more radio frequency (RF) transceivers).

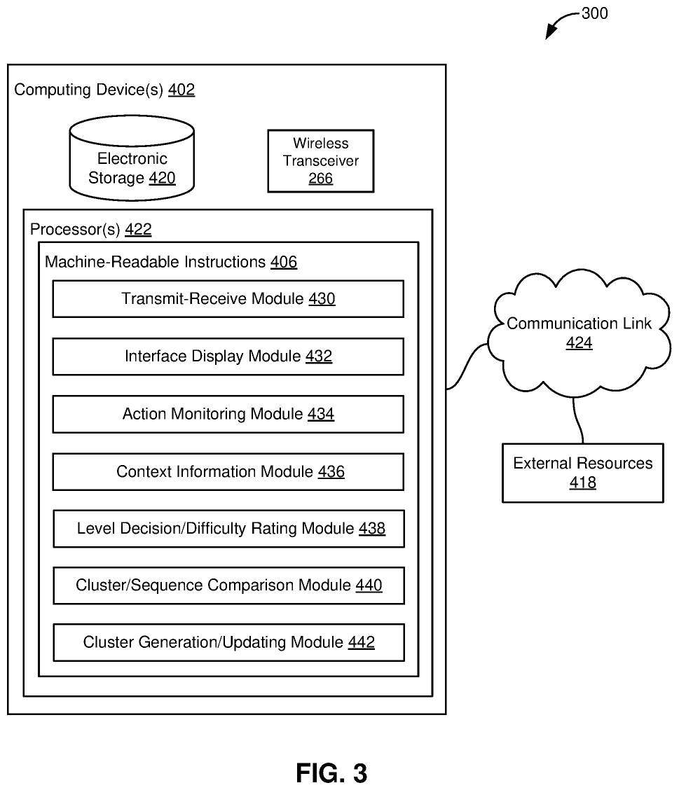

FIG. 3 is a component block diagram illustrating an example system 300 configured to suggest a more efficient action sequence to a user for achieving a result according to some embodiments. With reference to FIGS. 1-3, the system 300 may include one or more computing device(s) 402 (e.g., the computing device(s) 200, 320) and external resources 418 (e.g., AR glasses, AR servers), which may communicate via a wireless communication network 424. External resources 418 may include sources of information outside of the system 300, external entities participating with the system 300, or other resources. In some implementations, some or all of the functionality attributed herein to external resources 418 may be provided by resources included in the system 300. The system 300 may include a plurality of hardware, software, and/or firmware components operating together to provide the functionality attributed herein to the processor 422.

The computing device(s) 402 may include electronic storage 420 that may be configured to store information related to functions implemented by a transmit-receive module 430, an interface display module 432, an action monitoring module 434, a context information module 436, a level decision/difficulty rating module 438, a cluster/sequence comparison module 440, a cluster generation/updating module 442, and any other instruction modules.

The electronic storage 420 may include non-transitory storage media that electronically stores information. The electronic storage 420 may include one or both of system storage that is provided integrally (i.e., substantially non-removable) with the system 300 and/or removable storage that is removably connectable to the system 300 via, for example, a port (e.g., a universal serial bus (USB) port, a firewire port, etc.) or a drive (e.g., a disk drive, etc.). In various embodiments, electronic storage 420 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 420 may include one or more virtual storage resources (e.g., cloud storage, a virtual private network, and/or other virtual storage resources). The electronic storage 420 may store software algorithms, information determined by processor(s) 422, and/or other information that enables the system 200 to function as described herein.

The computing device(s) 402 may be configured by machine-readable instructions 406. Machine-readable instructions 406 may include one or more instruction modules. The instruction modules may include computer program modules. The instruction modules may include one or more of a the transmit-receive module 430, the interface display module 432, the action monitoring module 434, the context information module 436, the level decision/difficulty rating module 438, the cluster/sequence comparison module 440, the cluster generation/updating module 442, and other instruction modules (not illustrated). The computing device(s) 402 may include processor(s) 422 configured to implement the machine-readable instructions 406 and corresponding modules.

The processor(s) 422 may include one of more local processors that may be configured to provide information processing capabilities in the system 300. As such, the processor(s) 422 may include one or more of a digital processor, an analog processor, a digital circuit designed to process information, an analog circuit designed to process information, a state machine, and/or other mechanisms for electronically processing information. Although the processor(s) 422 is shown in FIG. 3 as a single entity, this is for illustrative purposes only. In some embodiments, the processor(s) 422 may include a plurality of processing units. These processing units may be physically located within the same device, or the processor(s) 422 may represent processing functionality of a plurality of devices distributed in the system 300.

In some embodiments, the processor(s) 422 executing the transmit-receive module 430 may be configured to transmit and receive information with the external resources 418 via the communication link 424.

In some embodiments, the processor(s) 422 executing the interface display module 432 may be configured to display a more efficient action sequence to a user via a display interface. In some embodiments, the processor(s) 422 executing the interface display module 432 may be configured to receive an input selection from a user via a display interface. In some embodiments, the processor(s) 422 executing the interface display module 432 may be configured to display, via a display interface of the computing device, one or more alternative system action sequences with a lower difficulty rating than the first difficulty rating. In some embodiments, the processor(s) 422 executing the interface display module 432 may be configured to display, via the display interface of the computing device, the one or more alternative system action sequences with a lower difficulty rating than the first difficulty rating in response to determining that the user action sequence requires more actions or interactions than the alternative one or more system action sequences. In some embodiments, the processor(s) 422 executing the interface display module 432 may be configured to display, via the display interface of the computing device, the one or more system action sequences with a lower difficulty rating than the first difficulty rating in response to determining that the user action sequence takes longer to perform or complete than the time to perform any of the one or more system action sequences. In some embodiments, the processor(s) 422 executing the interface display module 432 may be configured to receive a user selection indicating that the user action sequence is preferred by the user over the displayed one or more system action sequences with a lower difficulty rating.

In some embodiments, the processor(s) 422 executing the action monitoring module 434 may be configured to monitor user interactions with the computing device to recognize when a user action sequence including one or more user actions is performed by the user to achieve a particular result, such as accessing a file, starting a particular application, dialing a phone number, taking a photograph, etc. In some embodiments, the processor(s) 422 executing the action monitoring module 434 may be configured to determine whether the user action sequence has been performed a threshold number of times, in which comparing the first difficulty rating to one or more difficulty ratings of the cluster of multiple alternative system action sequences that produce the same result in the cluster database may be performed in response to determining that the user action sequence has been performed a threshold number of times.

In some embodiments, the processor(s) 422 executing the context information module 436 may be configured to analyze, measure, or otherwise determine context information including time and environment information regarding each action within a user action sequence.

In some embodiments, the processor(s) 422 executing the level decision/difficulty rating module 438 may be configured to determine a first difficulty rating of the user action sequence.

In some embodiments, the processor(s) 422 executing the cluster/sequence comparison module 440 may be configured to compare the first difficulty rating to one or more difficulty ratings of the cluster of multiple alternative system action sequences that produce the same result in the cluster database in response to determining that the cluster of multiple alternative system action sequences that produce the same result exists within the cluster database. In some embodiments, the processor(s) 422 executing the cluster/sequence comparison module 440 may be configured to determine whether the user action sequence has fewer actions than the one or more system action sequences. In some embodiments, the processor(s) 422 executing the cluster/sequence comparison module 440 may be configured to determine whether the user action sequence is executed slower than a time to perform any of the one or more system action sequences. In some embodiments, the processor(s) 422 executing the cluster/sequence comparison module 440 may be configured to determine whether a cluster of multiple system action sequences exists within a cluster database, in which each system action sequence of the multiple alternative user action sequences produces the same result. In some embodiments, the processor(s) 422 executing the cluster/sequence comparison module 440 may be configured to determine whether a system action sequence of the multiple alternative user action sequences includes the one or more user actions of the user action sequence in response to determining that the cluster of multiple system action sequences exists within the cluster database.

In some embodiments, the processor(s) 422 executing the cluster generation/updating module 442 may be configured to generate a new cluster including the user action sequence in response to determining that a cluster of multiple system action sequences that produce the result does not exist within the cluster database. In some embodiments, the processor(s) 422 executing the cluster generation/updating module 442 may be configured to update the cluster of multiple alternative system action sequences that produce the same result with the user action sequence in response to determining that a system action sequence of the multiple alternative user action sequences does not include the one or more user actions of the user action sequence. In some embodiments, the processor(s) 422 executing the cluster generation/updating module 442 may be configured to update the cluster of multiple alternative system action sequences that produce the same result to store the user action sequence with a lower difficulty rating than the one or more difficulty ratings of the displayed one or more system action sequences. In some embodiments, the processor(s) 422 executing the cluster generation/updating module 442 may be configured to change the first difficulty rating to a lower difficulty rating. In some embodiments, the processor(s) 422 executing the cluster generation/updating module 442 may be configured to change the one or more difficulty ratings of the displayed one or more system action sequences to be lower than the first difficulty rating.

The processor(s) 422 may execute the modules 430-442 and/or other modules by software, hardware, firmware, some combination of software, hardware, and/or firmware, and/or other mechanisms for configuring processing capabilities on processor(s) 422.

The description of the functionality provided by the different modules 430-442 is for illustrative purposes, and is not intended to be limiting, as any of modules 430-442 may provide more or less functionality than is described. For example, one or more of modules 430-442 may be eliminated, and some or all of its functionality may be provided by other ones of modules 430-442. As another example, processor(s) 422 may execute one or more additional modules that may perform some or all of the functionality attributed below to one of modules 430-442.

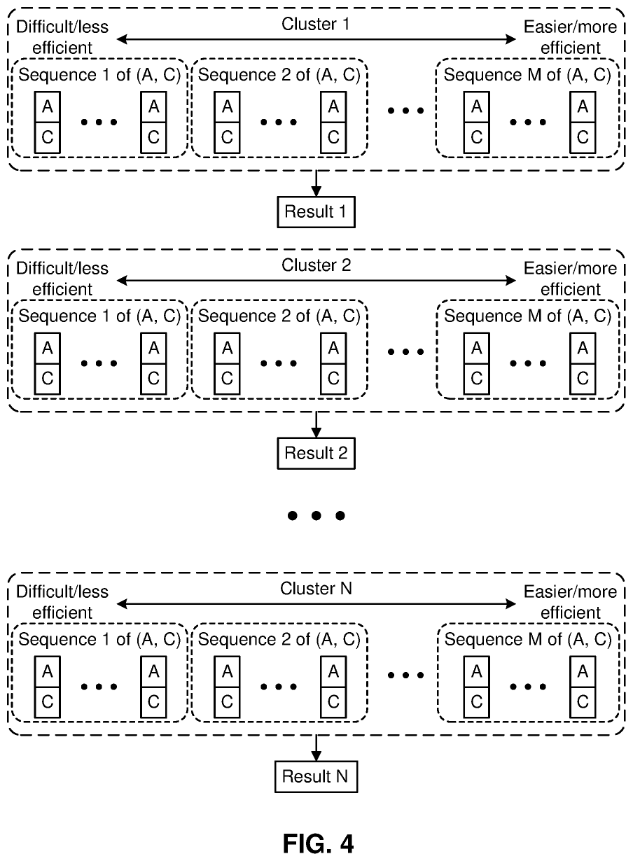

FIG. 4 is a block diagram illustrating example data structures for suggesting a more efficient action sequence to a user of a computing device for achieving a result according to some embodiments. With reference to FIGS. 1-4, data structures, which may be referred to as clusters, may be stored within a database (e.g., memory 220, 258, electronic storage 420) of a computing device (e.g., 200, 320, 402), and/or may be stored within an external database (e.g., external resources 418) communicatively connected to the computing device.

Each cluster may be associated with a specific result, and each cluster may have one or more action sequences including one or more actions “A” that may be performed to achieve the result. There may be any number N of clusters, each cluster associated with a different result, and each cluster may have any number M of action sequences for achieving the result associated with each cluster. For example, a Cluster 1 may have one or more action sequences that may be performed to achieve Result 1, a Cluster 2 may have one or more action sequences that may be performed to achieve Result 2, and a Cluster N may have one or more action sequences that may be performed to achieve Result N. Each system action sequence may include an action or a series of actions that may be performed to achieve a result. For example, Cluster 1 may include a Sequence 1, Sequence 2, and Sequence M that each include any number of different actions that may be sequentially performed by a user of the computing device to achieve the Result 1. For example, Cluster 1 may include Sequence 1, Sequence 2, and Sequence M each including at least one action that may be performed by a user to achieve a Result 1 of unlocking a phone. Sequence 1 may include an action such as entering a password, Sequence 2 may include an action such as providing a user thumbprint, and Sequence M may include a first action of raising the phone and a second action of shaking the phone to unlock.

The sequences in each cluster may be assigned or otherwise stored in association with a difficulty rating. For example, Cluster 1 may have a Sequence 1 with a high difficulty rating and a Sequence M with a comparatively low difficulty rating, thus indicating that the actions of Sequence 1 are less efficient for a user to perform than the actions of Sequence M. Each action “A” within an action sequence may be associated with context information “C” that may be used to determine or otherwise indicate a difficulty rating of the action sequence.

Context information may include any time information that may be associated with a specific action that may be performed by a user, including but not limited to (i) a time (e.g., timestamp) at which the action is performed, (ii) a time between the current associated action and a previous action in the action sequence, (iii) a time between the current associated action and a next action in the action sequence, and (iv) a duration to perform the action.

Context information may further include any environment information that may be associated with a specific action that may be performed by a user, including but not limited to (i) sensor information such as information measured by temperature sensors, humidity sensors, pressure sensors, infrared sensors, light sensors, sound sensors/microphone for voice recognition and other sound detection and conversion (i.e., analog-to-digital), user interface mechanisms such as touchpads and touch screens (e.g., fingerprint identification, capacitance-based touch recognition), (ii) computing device velocity, acceleration, and orientation information such as information measured and/or determined by accelerometers, and geopositioning via satellite tracking and base station and/or WiFi pinging or triangulation, (iii) optical information derived from a camera or camera sensors including object and/or facial recognition, iris/eye recognition, focal point distance, foreground and/or background distance, lighting and brightness levels, computing device steadiness, motion detection, and camera settings including camera zoom, video framerate, aspect ratio, etc., (iv) network connectivity information such as network type, network communication protocols, network uplink and downlink speeds, proximity to server/router/network device, network access permissions, and available networks, (v) device connectivity information such as connected device(s), connected device communication protocols, and connected device signal strength, (vi) application information such as type of software application (e.g., photo editing application, internet browser application, mapping application), application version, and application user interfacing (e.g., selectable user inputs/buttons), and (vii) device information such as brand, model, and operating system type and version.

An action sequence may further be assigned and/or indicate a difficulty rating for the action sequence. In some embodiments the difficulty rating may be based on a number of steps involved in each user action sequences, a complexity of the user action sequences, context and/or environmental conditions in which each multiple alternative user action sequence is more or less difficult, and other measures of difficulty. For example, the difficulty rating may be based on a total estimated time and/or average time to perform all of the actions within the action sequence, and/or the total number of actions within the action sequence. For example, in Cluster 2, Sequence 1 may have more actions than Sequence 2, and may therefore be attributed a higher difficulty rating than Sequence 2. As another example, Sequence 2 may have fewer actions than Sequence M, but the actions of Sequence M may be performed in a shorter time than the actions of Sequence 2. Thus, Sequence M may be attributed a lower difficulty rating than Sequence 2. As a further example, Sequence 1 may have fewer actions than Sequence 2, but the actions of Sequence 1 may be attributed a higher difficulty rating than the actions of Sequence 2 based on the context information of the actions in both action sequences (i.e., actions in Sequence 1 are more difficult for a user to perform).

Additionally, the difficulty rating may take into account how each user action sequence could be affected by foreseeable operating or environmental conditions. For example, if an action sequence involves pressing a small icon on a touch sensitive display, the difficulty rating may include a factor that is applied if accelerometers in the computing device indicate that the device is experiencing movement and/or vibrations (e.g., when the user is walking or in a moving vehicle) that could make it difficult to accurately touch a small icon. In such embodiments, an operating or environmental condition and associated adjustment factor for the difficulty rating may be associated with the corresponding action sequence in the cluster of multiple alternative system action sequences that produce the same result stored in the cluster database.

The difficulty rating may be any type of grading, leveling, ratio, percentage, or value that may be used to represent that one action sequence may be easier and/or more efficient for a user to perform than another action sequence.

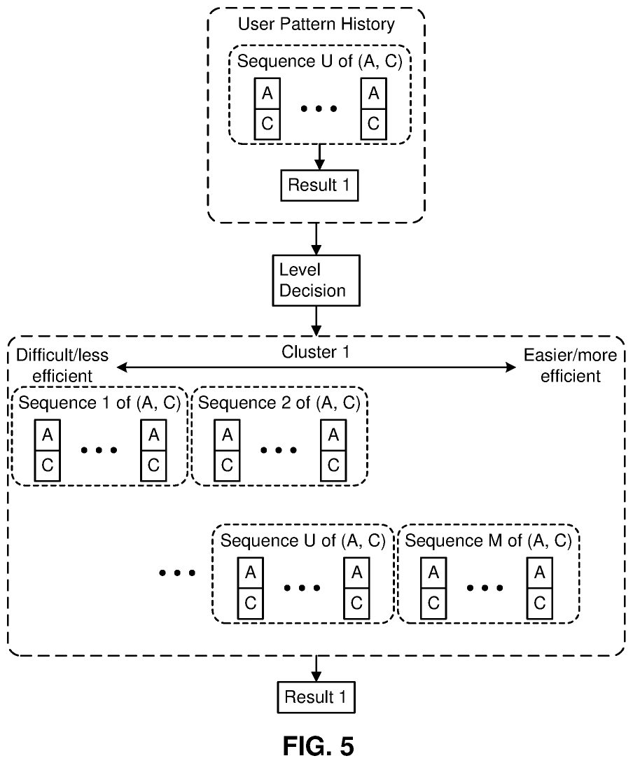

FIG. 5 is a block diagram illustrating an example updated data structure for suggesting a more efficient action sequence to a user of a computing device for achieving a result according to some embodiments. With reference to FIGS. 1-5, a user pattern history with a specific result may be used to update a cluster database with the same result or may be used to determine a difficulty level of a user action sequence based on an equivalent action sequence in the cluster of multiple alternative system action sequences that produce the same result stored within the cluster database. For example, the User Pattern History may include a Sequence U performed by a user of a computing device to achieve the Result 1. The computing device, having monitored and recorded each action of the Sequence U and any associated context information, may search a cluster database to determine if a cluster with Result 1 exists. In this illustrative example, Cluster 1 with Result 1 may exist, but no action sequence with the same actions as Sequence U may exist. Thus, the Cluster 1 may be updated to include the user pattern history including the Sequence U. A level decision may be performed by the computing device and/or a database storing the cluster information to attribute a difficulty level or rating to the Sequence U. The Sequence U may then be stored as part of the Cluster 1 with the determined difficulty level, and the computing device may provide, via a display interface, an action sequence (e.g., Sequence M) to the user that may be easier or more efficient to perform than the Sequence U (i.e., after the user initially performs the Sequence U and prior to the user attempting to perform the Sequence U again).

Following the above example, a user may subsequently and iteratively perform the Sequence U. Since the Cluster 1 has been updated with the Sequence U and accompanying difficulty rating, the computing device and/or cluster database may not need to perform another Level Decision to determine a difficulty rating of the Sequence U. Instead, the computing device and/or cluster database may determine that Sequence U is already stored within the Cluster 1, may compare the difficulty rating of the Sequence U to other sequences within the Cluster 1 to determine that an easier or more efficient action Sequence M exists within the Cluster 1, and may provide the Sequence M to the user as a recommended course of action for the next time the user attempts to achieve the Result 1.

In some embodiments in which the actions of Sequence U are already stored as a sequence within the Cluster 1 (e.g., as Sequence 2), the Cluster 1 would not need to be updated with the User Pattern History. Instead, the computing device may determine that Sequence U performed by the user is equivalent to Sequence 2 and therefore has a difficulty rating already attributed to Sequence 2, and may then provide Sequence M to the user via a display interface as a more efficient option than the Sequence U that the user had recently performed.

In some embodiments, the difficulty rating of the user action Sequence U may be updated to be the easiest or most efficient action sequence over the suggested action sequence, such that the user action sequence is updated to have a stored difficulty level that is less than the stored difficulty level associated with the suggested action sequence. For example, the user action sequence may have a difficulty level of 5 (i.e., high; more difficult; less efficient) as compared to a suggested action sequence with a difficulty level of 2 (i.e., lower; less difficult; more efficient). The user, despite being provided with the suggested action sequence having a lower difficulty rating, may select an input indicating a preference for the user action sequence, and the user action sequence may be updated and stored within the cluster of multiple alternative system action sequences that produce the same result in the cluster database with a difficulty rating that is lower than the difficulty rating of the suggested action sequence (e.g., user action sequence difficulty level is 1, suggested action sequence difficulty is 2).

In some embodiments, the difficulty level of the suggested action sequence may be updated to be more difficult if a user prefers a user action sequence over the suggested action sequence. For example, if the users selects an option to prefer the Sequence U, the suggested action sequence (e.g., Sequence M) may be updated to have a difficulty rating that is greater than the user action Sequence U. Then, when the user again performs the user action sequence repeatedly, the next least difficult action sequence within the cluster of multiple alternative system action sequences that produce the same result may be provided to the user. The user may still prefer the user action sequence over the second recommended action sequence, and the processor may continue to repeatedly provide a next most efficient action sequence within the cluster of multiple alternative system action sequences that produce the same result after each user action sequence is performed until the user has been presented with and continues to deny all of the suggested action sequences in the cluster of multiple alternative system action sequences that produce the same result.

In some embodiments in which a user selects an option indicating a preference to use the user action sequence over a suggested action sequence, other action sequences in the cluster of multiple alternative system action sequences that produce the same result that have not yet been suggested to the user and are more efficient than the user action sequence but less efficient than the suggested action sequence may also be updated to have a higher difficulty rating than the user action sequence. Thus, the user may not be presented with additional suggested action sequences that are less efficient than the recommended action sequence initially provided to the user after performing the user action sequence for the first time and selecting a preference for the user action sequence over the first suggested action sequence.

In some embodiments, a cluster database may be updated with user action sequences from other multiple users. Thus, for example, a user, despite already selecting an input indicating a preference for the user action sequence, may be presented with, upon subsequent and/or repeated implementation of the user action sequence, a more efficient or easier action sequence that was newly or recently added to the cluster of multiple alternative system action sequences that produce the same result based on a user pattern history of another user operating another computing device communicatively connected to the cluster database.

In some embodiments, clusters and associated action sequences may be default clusters with default associated action sequences defined by a manufacturer of the computing device prior to user operation. In some embodiments, the clusters of multiple alternative system action sequences that produce same results may be generated based on user action sequences, and the action sequences associated with the user-generated clusters may have difficulty ratings determined by the computing device based on the associated context information measured and gathered by the computing device during user operation.

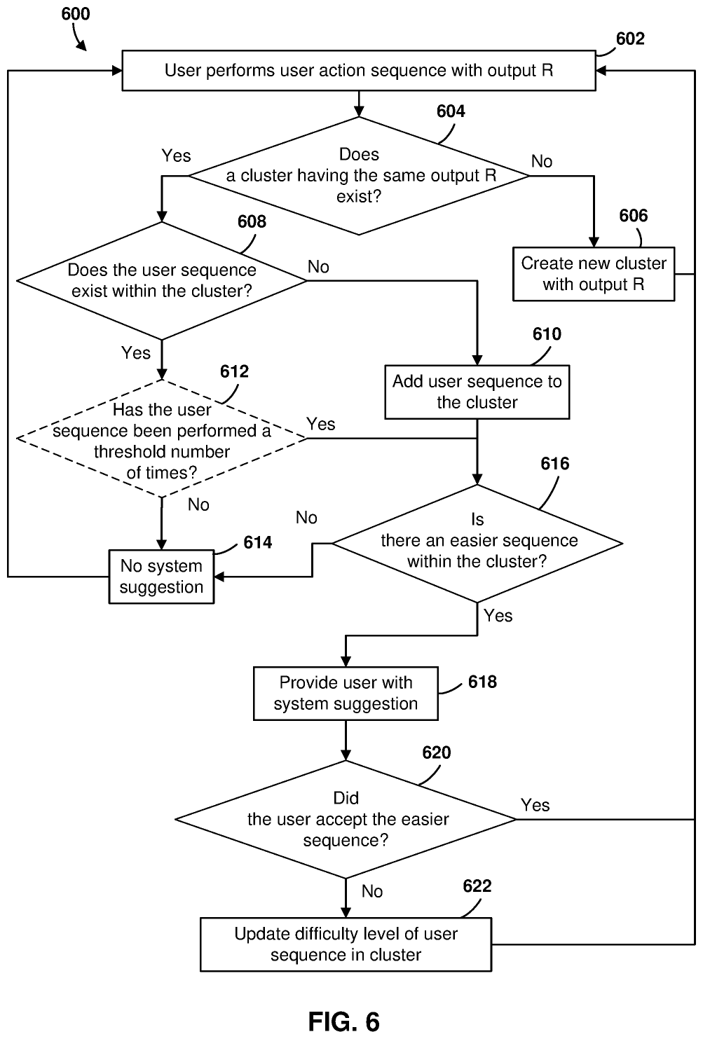

FIG. 6 is a process flow diagram of a method 600 for suggesting a more efficient action sequence to a user of a computing device for achieving a result according to some embodiments. With reference to FIGS. 1-6, the method 600 may be implemented by a processor (e.g., 210, 212, 214, 216, 218, 252, 260, 422) of a computing device (e.g., 100, 320, 402). In some embodiments, the method 600 may be implemented in part within an external database (e.g., external storage 420) communicatively coupled to the computing device. For example, the processes involving storing and updating clusters, action sequences, and difficulty levels may be performed in part on a processor of an external database at the direction of the computing device.

In block 602, a user of a computing device may perform a user action sequence that produces a result or output “R.” The user action sequence may include one or more actions that may be performed to achieve the result, and each action within the user action sequence may be associated and/or stored with context information measured or otherwise determined by the computing device.

In determination block 604, the computing device may determine whether a cluster database includes a cluster that has the result R. The cluster database may be included as part of the computing device, or may be located externally on a database server communicatively coupled to the computing device. The computing device may analyze or search the cluster database and compare the result R with the results of each cluster of multiple alternative system action sequences that produce the same result within the cluster database to determine whether any of the clusters of multiple alternative system action sequences have a same result R.

In response to determining that a cluster of multiple alternative system action sequences with the same result R does not exist within the cluster database (i.e., determination block 604=“No”), the user computing device may create a new cluster of multiple alternative system action sequences with result R within the cluster database as described in block 606. For example, the computing device may create a new cluster with result R, in which the cluster includes a stored action sequence based on the user action sequence. Additionally, in creating the new cluster of multiple alternative system action sequences with result R, the computing device may assign a difficulty rating to the stored action sequence based on context information for each action within the user action sequence.

In response to determining that a cluster of multiple alternative system action sequences with the same result R does exist within the cluster database (i.e., determination block 604=“Yes”), the computing device may determine whether the user action sequence already exists within the cluster of multiple alternative system action sequences as described in determination block 608. For example, the computing device may search the cluster with result R to determine if an action sequence has the same actions as the user action sequence.

In response to determining that the user sequence does not exist within the cluster (i.e., determination block 608=“No”), the user computing device may update, add to, or otherwise store the user action sequence in the cluster of multiple alternative system action sequences with result R as described in block 610. For example, the computing device may store the user action sequence in a cluster of multiple alternative system action sequences with result R, in which the cluster includes one or more other action sequence that may be performed to achieve result R. Additionally, the computing device may perform a Level Decision and assign a difficulty rating to the stored action sequence based on context information for each action within the user action sequence.

After adding the user sequence to the cluster of multiple alternative system action sequences that produce the same result in block 610, the user computing device may determine whether there is an easier sequence of actions within the cluster of multiple alternative system action sequences determination block 616. For example, the computing device may search or analyze the action sequences within the cluster, and compare difficulty ratings of the action sequences to a difficulty rating of the user action sequence.

In response to determining that a cluster of multiple alternative system action sequences with the same result R does exist within the cluster database (i.e., determination block 608=“Yes”), the computing device may determine whether the user sequence has been performed a threshold number of times as described in determination block 612. For example, the computing device may maintain a counter to determine how many times a user performs a user action sequence, and may perform an action based on determination block 612 upon reaching the counter value. In some embodiments, the processes in determination block 612 may be optional, and instead, in response to determining that a cluster of multiple alternative system action sequences with the same result R does exist within the cluster database (i.e., determination block 608=“Yes”), the computing device may determine whether an easier or more efficient action sequence exists within the cluster of multiple alternative system action sequences in determination block 616 as described.

In response to determining that the user sequence has not been performed a threshold number of times (i.e., determination block 612=“No”), the computing device may provide no recommended action sequence or system suggestion to the user in block 614. For example, the computing device may refrain from providing the user with a more efficient action sequence to achieve the result R until the user performs a less efficient user action sequence multiple times. Thereafter, the computing device may continue to monitor user action sequences in block 602 as described.

In response to determining that the user sequence has been performed a threshold number of times (i.e., determination block 612=“Yes” or determination block 608=“Yes” in embodiments in which determination block 612 is not implemented), the computing device may determine whether an easier or more efficient action sequence exists within the cluster of multiple alternative system action sequences that produce the same result in determination block 616 as described.

In response to determining that an easier or more efficient action sequence does not exist within the cluster of multiple alternative system action sequences (i.e., determination block 616=“No”), the computing device may provide no recommended action sequence or system suggestion to the user as described in block 614. For example, the computing device may refrain from providing the user with an action sequence until the cluster of multiple alternative system action sequences is updated with newer, more action sequences that may be more efficient than the user action sequence (i.e., from a collective cluster database of multiple user's user action sequences).

In response to determining that an easier or more efficient action sequence exists within the cluster of multiple alternative system action sequences (i.e., determination block 616=“Yes”), the computing device may provide a recommended action sequence or system suggestion to the user in block 618. For example, the computing device may determine that one or more action sequences with the cluster of multiple alternative system action sequences have a lower difficulty rating than the user action sequence, and may then provide at least one more efficient action sequence to the user via a display interface of the computing device. Thus, the user may be notified of a more efficient process to achieve the result R for any subsequent attempts at achieving the result R.

In determination block 620, the computing device may determine whether the user selects an input to accept the recommended action sequence. Upon providing the recommended action sequence with a lower difficulty rating than the user action sequence as described in block 618, the computing device may display a prompt or selectable option to the user to allow the user to accept the recommended action sequence or to assign a preference to the user action sequence over the recommended action sequence. Thereafter, the computing device may continue to monitor user action sequences in block 602 as described.

In response to determining that the user selected an input to accept the recommended action sequence (i.e., determination block 620=“Yes”), the user computing device may (i) update the user action sequence (or equivalent action sequence with same actions in the cluster of multiple alternative system action sequences) with a higher difficulty rating than the recommended action sequence, (ii) update the recommended action sequence with a lower difficulty rating than the user action sequence, (iii) both (i) and (ii), or (iv) do nothing. The user accepting the recommended action sequence may signify that the user may prefer the recommended action sequence to achieve the result R in subsequent attempts to achieve result R, and that the user action sequence should not be recommended in any further attempts at achieving result R.

In response to determining that the user selected an input to decline the recommended action sequence (i.e., determination block 620=“No”), the user computing device may (i) update the user action sequence (or equivalent action sequence with same actions in the cluster of multiple alternative system action sequences) with a lower difficulty rating than the recommended action sequence, and/or (ii) update the recommended action sequence with a higher difficulty rating than the user action sequence in block 622. The user declining the recommended action sequence may signify that the user may prefer the user action sequence to achieve the result R in subsequent attempts to achieve result R, and that the recommend action sequence should not be recommended in any further attempts at achieving result R. Thereafter, the computing device may continue to monitor user action sequences in block 602 as described.

In some embodiments, the user may be provided with an easier and/or more efficient action sequence while a user is simultaneously performing an action sequence to achieve a certain result. For example, a user may perform a number of actions to achieve a result of mapping a destination, such as opening an internet browser application, entering address information, searching for the correct address, selecting the address to open the address within a mapping application within the browser application, then selecting an option to open the address directly in a mapping application including more features than the browser-based mapping application. During this process, the computing device may determine that the user is attempting to achieve a result of mapping a destination by recognizing that the first few steps are part of an action sequence of a specific cluster of multiple alternative system action sequences with a result of mapping a destination. Prior to the user completing the action sequence as described above, the computing device may provide the user with remaining steps of a more efficient action sequence to allow the user to achieve the result in fewer steps, in less time, and/or with less effort. For example, after entering the address information in the browser application search bar, the computing device may determine a more efficient action sequence exists, and may provide the user with a suggestion or recommendation to open the address information within the mapping application instead of the browser application prior to the user completing the action sequence.

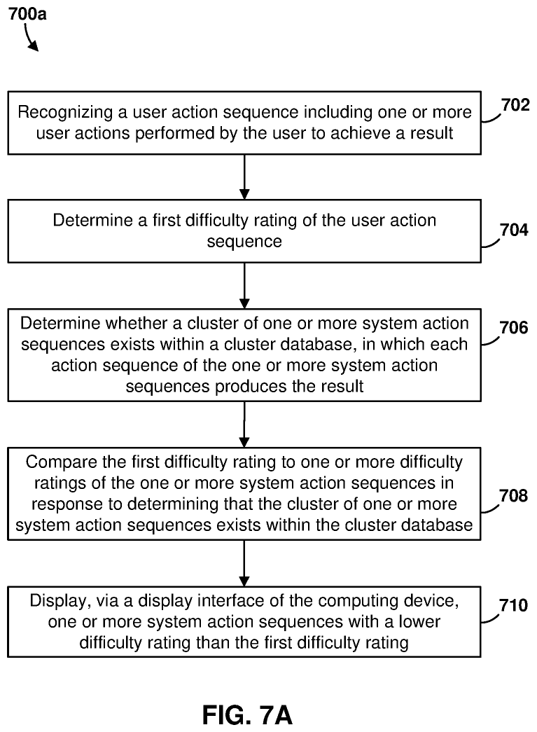

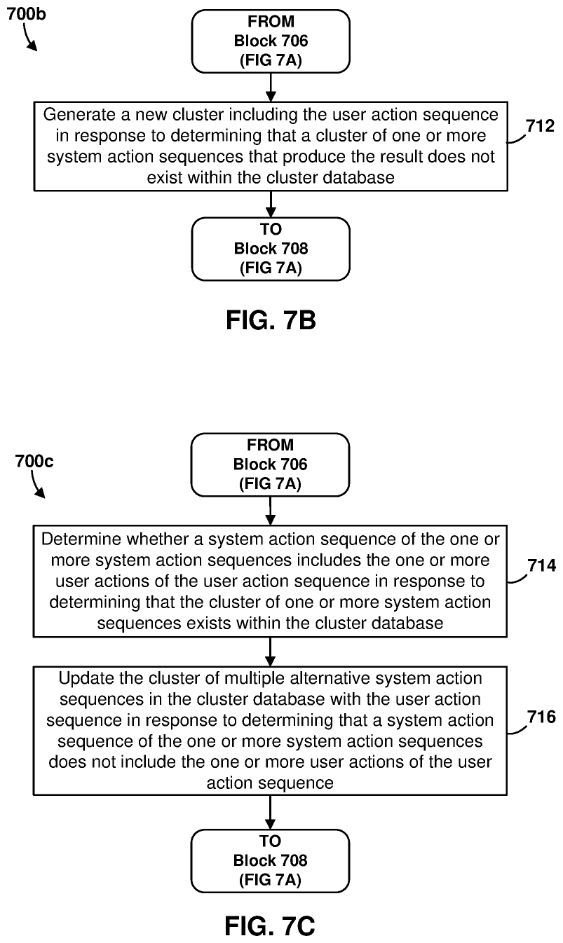

FIG. 7A is a process flow diagram of an example method 700a that may be performed by a processor of a computing device for suggesting a more efficient action sequence to a user for achieving a result in accordance with various embodiments. FIGS. 7B-7E are process flow diagrams of example operations 700b-700e that may be performed as part of the method 700a as described for suggesting a more efficient action sequence to a user for achieving a result in accordance with some embodiments. With reference to FIGS. 1-7E, the method 700a and the operations 700b-700e may be performed by a processor (e.g., 210, 212, 214, 216, 218, 252, 260, 422) of a computing device (e.g., 100, 320, 402). In some embodiments, the processor (e.g., 210, 212, 214, 216, 218, 252, 260, 422) may be configured to perform the operations by processor-executable instructions stored in a non-transitory processor-readable medium (e.g., 220, 258, 420). Means for performing each of the operations of the method 700a and the operations 700b-700e may be a processor of the systems 100, 200, 300, such as the processors 210, 212, 214, 216, 218, 252, 260, 422, and/or the like as described with reference to FIGS. 1-6.

In block 702, the processor of the receiving computing device may perform operations including recognizing a user action sequence including one or more user actions performed by the user to achieve a result. In the operations performed in block 702, the processor may monitor user interactions with the computing device, such as user interactions with a touch-sensitive display, button presses and movements of the device, to recognize when the user interactions lead to the computing device generating or producing a specific result, such as starting an application, activating a device functionality (e.g., a camera), accessing a file (e.g., a photograph), initiating or answering a phone call, and the like. The computing device may record each action within the user action sequence that the user performed that resulted in the specific result. Thus, the processor may also associate each action with context and environment information regarding the user action sequence and the specific result, and store this information for use in determining a difficulty rating or level of the user action sequence. Means for performing the operations of block 702 may include a processor (e.g., 210, 212, 214, 216, 218, 252, 260, 422) of a computing device (e.g., 100, 320, 402) executing the action monitoring module 434.

In block 704, the processor of the receiving computing device may perform operations including determining a first difficulty rating of the user action sequence. The computing device may determine a difficulty rating of the user action sequence based on context information associated with each action within the action sequence identified and stored in block 702. The difficulty rating may be based on a number of steps involved in each user action sequences, a complexity of the user action sequences, context and/or environmental conditions in which each multiple alternative user action sequence is more or less difficult, and other measures of difficulty. In some embodiments, the first difficulty rating may be determined by analyzing a total time to perform the user action sequence and/or the total number of actions within the user action sequence. Means for performing the operations of block 704 may include a processor (e.g., 210, 212, 214, 216, 218, 252, 260, 422) of a computing device (e.g., 100, 320, 402) executing the level decision/difficulty rating module 438 and the context information module 436.

In block 706, the processor of the receiving computing device may perform operations including determining whether a cluster of multiple alternative system action sequences for achieving the same specific result exists within a cluster database. The cluster database may be an organization of data in memory that associated different user-interaction sequences that a user can use to cause the computing device to produce or yield the same specific results, in which each system action sequence of the multiple alternative user action sequences produces the same result. In particular, the computing device may determine whether a cluster database exists that stores user action sequences different from the user action sequence recognized in block 702 that when performed achieve a same result as the recognized user action sequence. In addition to storing multiple alternative user action sequences to achieve a given result (i.e., associating multiple user action sequences with a given result), the cluster database may store a difficulty rating associated with each of the multiple alternative user action sequences. As described, the difficulty rating may be based on a number of steps involved in each user action sequences, a complexity of the user action sequences, context and/or environmental conditions in which each multiple alternative user action sequence is more or less difficult, and other measures of difficulty. Means for performing the operations of block 706 may include a processor (e.g., 210, 212, 214, 216, 218, 252, 260, 422) of a computing device (e.g., 100, 320, 402) executing the cluster/sequence comparison module 440.

In block 708, the processor of the receiving computing device may perform operations including comparing the first difficulty rating to one or more difficulty ratings of the multiple alternative user action sequences in response to determining that the cluster of multiple system action sequences exists within the cluster database. The computing device may compare the difficulty rating of the user action sequence against the difficulty ratings of system action sequences within the cluster of multiple system action sequences to determine whether any of the system action sequences are more efficient or easier to use than the user action sequence for achieving the result. In some embodiments, comparing the first difficulty rating to one or more difficulty ratings of the multiple alternative user action sequences may include determining whether the user action sequence has fewer actions than one or more of the multiple alternative system action sequences. In some embodiments, comparing the first difficulty rating to one or more difficulty ratings of the multiple alternative user action sequences may include determining whether the user action sequence is executed slower than the time required to perform any of the multiple alternative user action sequences. Means for performing the operations of block 708 may include a processor (e.g., 210, 212, 214, 216, 218, 252, 260, 422) of a computing device (e.g., 100, 320, 402) executing the cluster/sequence comparison module 440.

In block 710, the processor of the receiving computing device may perform operations including displaying, via a display interface of the computing device, one or more of the multiple alternative system action sequences that have a lower difficulty rating than the first difficulty rating. The computing device may display at least one system action sequence to a user to inform the user of a more efficient course of action that may be used in subsequent attempts to achieve the result instead of the user action sequence. In some embodiments, displaying, via the display interface of the computing device, the one or more system action sequences with a lower difficulty rating than the first difficulty rating may include displaying the one or more system action sequences with a lower difficulty rating than the first difficulty rating in response to determining that the user action sequence requires more actions than the one or more system action sequences. In some embodiments, displaying, via the display interface of the computing device, the one or more system action sequences with a lower difficulty rating than the first difficulty rating may include displaying the one or more system action sequences with a lower difficulty rating than the first difficulty rating in response to determining that the user action sequence takes longer to perform or complete than the time to perform any of the multiple alternative user action sequences. Means for performing the operations of block 710 may include a processor (e.g., 210, 212, 214, 216, 218, 252, 260, 422) of a computing device (e.g., 100, 320, 402) executing the interface display module 432.

FIG. 7B illustrates operations 700b that may be performed as part of the method 700a for suggesting a more efficient action sequence to a user for achieving a result in accordance with some embodiments. With reference to FIGS. 1-7B, following the operations in block 706, the processor of the computing device (e.g., 100, 320, 402) may perform operations including generating a new cluster of multiple alternative system action sequences including the user action sequence in response to determining that a cluster of multiple alternative system action sequences that produce the same result does not exist within the cluster database in block 712. The processor of the computing device, as part of the process of generating the cluster of multiple alternative system action sequences that produce the same result including the user action sequence, may determine a difficulty rating of the user action sequence, and store the user action sequence within the generated cluster of multiple alternative system action sequences that produce the same result in the cluster database in association with the determined difficulty rating. Means for performing the operations of block 712 may include a processor (e.g., 210, 212, 214, 216, 218, 252, 260, 422) of a computing device (e.g., 100, 320, 402) executing the level decision/difficulty rating module 438 and cluster generation/updating module 442.

After the operations in block 712, the processor may perform the operations in block 708 as described.

FIG. 7C illustrates operations 700c that may be performed as part of the method 700a for suggesting a more efficient action sequence to a user for achieving a result in accordance with some embodiments. With reference to FIGS. 1-7C, following the operations in block 706, the processor of the computing device (e.g., 100, 320, 402) may perform operations including determining whether a system action sequence of the multiple alternative user action sequences includes the one or more user actions of the user action sequence in response to determining that a cluster of multiple alternative system action sequences that produce the same result exists within the cluster database in block 714. In other words, the computing device may analyze the cluster of multiple alternative system action sequences to determine whether a system action sequence with the same actions of the user action sequence already exists within the cluster of multiple alternative system action sequences. Means for performing the operations of block 714 may include a processor (e.g., 210, 212, 214, 216, 218, 252, 260, 422) of a computing device (e.g., 100, 320, 402) executing the level decision/difficulty rating module 438 and cluster/sequence comparison module 440.

In block 716, the processor of the computing device (e.g., 100, 320, 402) may perform operations including updating the cluster of multiple alternative system action sequences in the cluster database with the user action sequence in response to determining that a system action sequence of the one or more system action sequences does not include the one or more user actions of the user action sequence. Means for performing the operations of block 716 may include a processor (e.g., 210, 212, 214, 216, 218, 252, 260, 422) of a computing device (e.g., 100, 320, 402) executing the cluster generation/updating module 442.

After the operations in block 716, the processor may perform the operations in block 708 of the method 700 as described.

FIG. 7D illustrates operations 700d that may be performed as part of the method 700a for suggesting a more efficient action sequence to a user for achieving a result in accordance with some embodiments. With reference to FIGS. 1-7D, following the operations in block 706, the processor of the computing device (e.g., 100, 320, 402) may perform operations including determining whether the user action sequence has been performed a threshold number of times in block 718. The computing device may maintain a counter to determine whether a user repeatedly implements a specific user action sequence, and may inly provide the user with a potential more efficient system action sequence after a threshold value of the counter has been reached. Means for performing the operations of block 718 may include a processor (e.g., 210, 212, 214, 216, 218, 252, 260, 422) of a computing device (e.g., 100, 320, 402) executing the action monitoring module 434.

After the operations in block 718, the processor may perform the operations in block 708 as described, in which comparing the first difficulty rating to one or more difficulty ratings of the multiple alternative system action sequences is performed in response to determining that the user action sequence has been performed a threshold number of times.

FIG. 7E illustrates operations 700e that may be performed as part of the method 700a for suggesting a more efficient action sequence to a user for achieving a result in accordance with some embodiments. With reference to FIGS. 1-7E, following the operations in block 710, the processor of the computing device (e.g., 100, 320, 402) may perform operations including receiving a user selection indicating that the user action sequence is preferred by the user over the displayed one or more system action sequences with a lower difficulty rating in block 720. The user may select, via a display interface of the computing device, an input or selection indicating that the system action sequence provided to the user with a lower difficulty rating than the user action sequence is not a preferred method to achieve the result, and should therefore not be recommended again when the user subsequently and/or repeatedly performs the user action sequence. Means for performing the operations of block 720 may include a processor (e.g., 210, 212, 214, 216, 218, 252, 260, 422) of a computing device (e.g., 100, 320, 402) executing the interface display module 432.

In block 722, the processor of the computing device (e.g., 100, 320, 402) may perform operations including updating the cluster database by storing the user action sequence with a lower difficulty rating than the one or more difficulty ratings of the displayed one or more system action sequences. In some embodiments, updating the cluster database by storing the user action sequence with a lower difficulty rating than the one or more difficulty ratings of the displayed one or more system action sequences may include changing the first difficulty rating to a lower difficulty rating. In some embodiments, updating the cluster database by storing the user action sequence with a lower difficulty rating than the one or more difficulty ratings of the displayed one or more system action sequences may include changing the one or more difficulty ratings of the displayed one or more system action sequences to be lower than the first difficulty rating. Means for performing the operations of block 714 may include a processor (e.g., 210, 212, 214, 216, 218, 252, 260, 422) of a computing device (e.g., 100, 320, 402) executing the cluster generation/updating module 442.

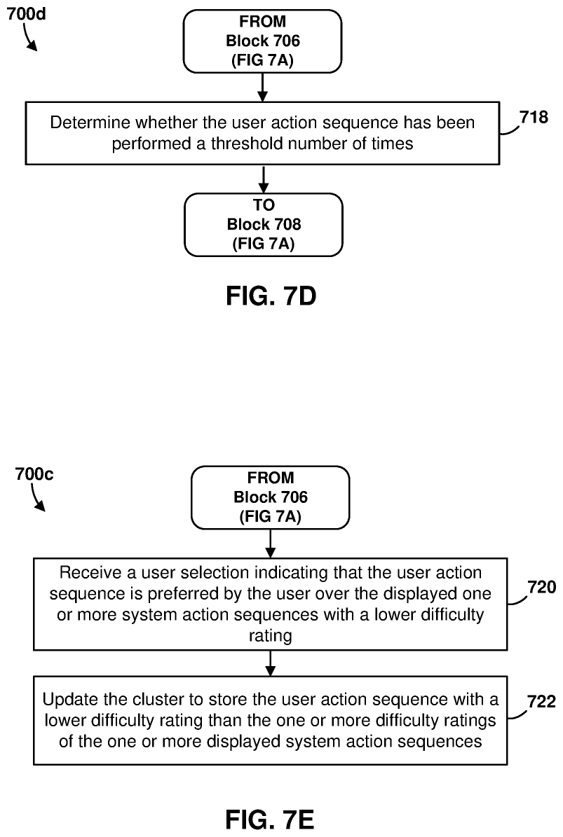

The various embodiments (including, but not limited to, embodiments described above with reference to FIGS. 1-7E) may be implemented in a wide variety of computing systems include a laptop computer 800 an example of which is illustrated in FIG. 8. With reference to FIGS. 1-8, a laptop computer may include a touchpad touch surface 817 that serves as the computer's pointing device, and thus may receive drag, scroll, and flick gestures similar to those implemented on computing devices equipped with a touch screen display and described above. A laptop computer 800 will typically include a processor 802 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a floppy disc drive 814 and a compact disc (CD) drive 815 coupled to the processor 802. The laptop computer 800 may include a touchpad 817, a keyboard 818, and a display 819 all coupled to the processor 802. Other configurations of the computing device may include a computer mouse or trackball coupled to the processor (e.g., via a USB input) as are well known, which may also be used in conjunction with the various embodiments.

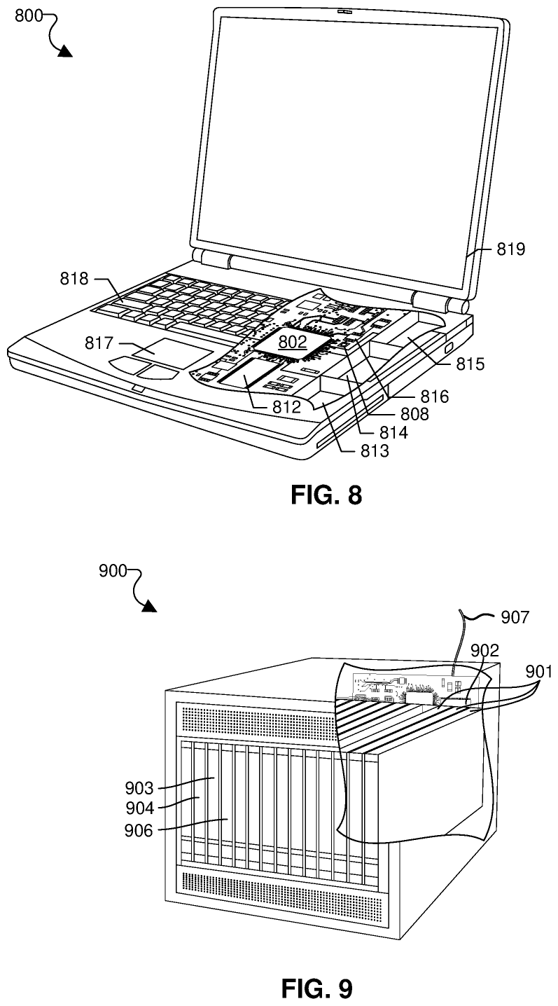

FIG. 9 is a component block diagram of a network computing device 900, such as a base station (e.g., base station 350), suitable for use with various embodiments. Such network computing devices (e.g., base stations, such as gNBs, eNBs, etc.) may include at least the components illustrated in FIG. 9. With reference to FIGS. 1-9, the network computing device 900 may include a processor 901 coupled to volatile memory 902 and a large capacity nonvolatile memory, such as a disk drive 903.

The network computing device 900 may also include a peripheral memory access device such as a floppy disc drive, compact disc (CD) or digital video disc (DVD) drive 906 coupled to the processor 901. The network computing device 900 may also include network access ports 904 (or interfaces) coupled to the processor 901 for establishing data connections with a network, such as the Internet and/or a local area network coupled to other system computers and servers.

The network computing device 900 may include one or more antennas 907 for sending and receiving electromagnetic radiation that may be connected to a wireless communication link. The network computing device 900 may include additional access ports, such as USB, Firewire, Thunderbolt, and the like for coupling to peripherals, external memory, or other devices.

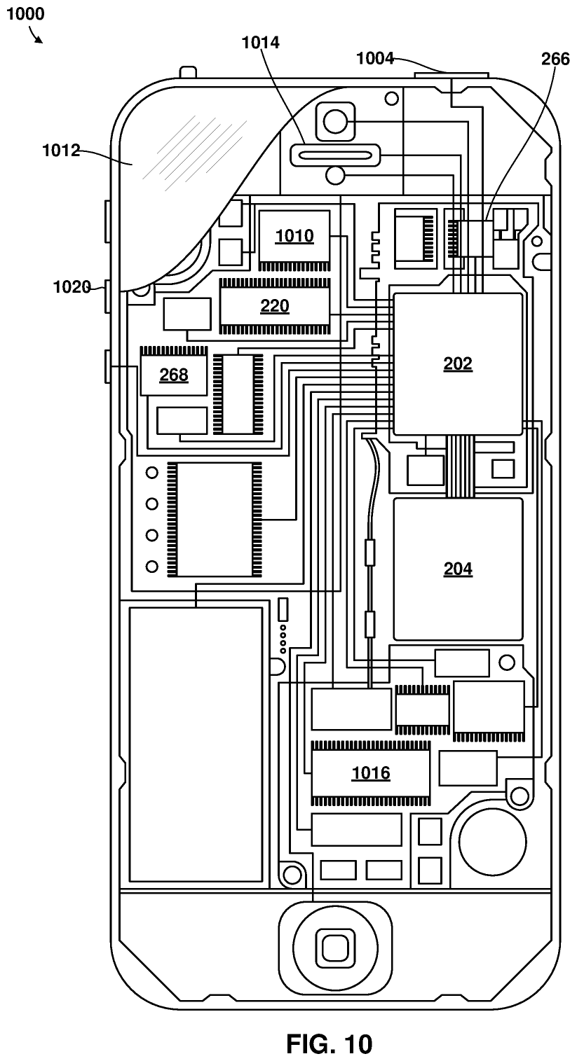

FIG. 10 is a component block diagram of a computing device 1000 suitable for use with various embodiments. With reference to FIGS. 1-10, various embodiments may be implemented on a variety of computing devices 1000 (e.g., computing device 120, 320, 402), an example of which is illustrated in FIG. 10 in the form of a smartphone. The computing device 1000 may include a first SoC 202 (e.g., a SoC-CPU) coupled to a second SoC 204 (e.g., a 5G capable SoC). The first and second SoCs 202, 204 may be coupled to internal memory 1016, a display 1012, and to a speaker 1014. The first and second SoCs 202, 204 may also be coupled to at least one SIM 268 and/or a SIM interface that may store information supporting a first 5GNR subscription and a second 5GNR subscription, which support service on a 5G non-standalone (NSA) network.

The computing device 1000 may include an antenna 1004 for sending and receiving electromagnetic radiation that may be connected to a wireless transceiver 266 coupled to one or more processors in the first and/or second SoCs 202, 204. The computing device 1000 may also include menu selection buttons or rocker switches 1020 for receiving user inputs.

The computing device 1000 also includes a sound encoding/decoding (CODEC) circuit 1010, which digitizes sound received from a microphone into data packets suitable for wireless transmission and decodes received sound data packets to generate analog signals that are provided to the speaker to generate sound. Also, one or more of the processors in the first and second SoCs 202, 204, wireless transceiver 266 and CODEC 1010 may include a digital signal processor (DSP) circuit (not shown separately).

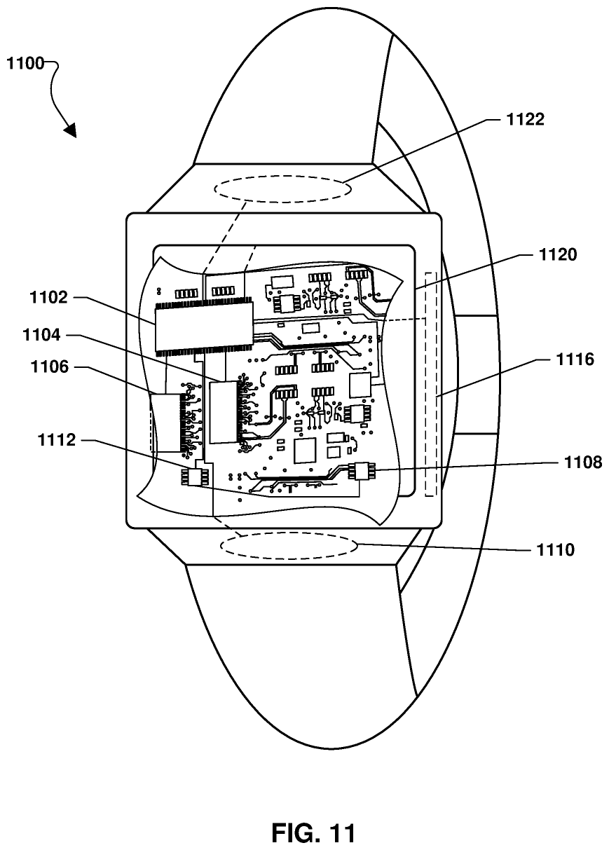

The various embodiments may be implemented within a variety of computing devices, such as a wearable computing device. FIG. 11 illustrates an example wearable computing device in the form of a smart watch 1100 according to some embodiments. A smart watch 1100 may include a processor 1102 coupled to internal memories 1104 and 1106. Internal memories 1104, 1106 may be volatile or non-volatile memories, and may also be secure and/or encrypted memories, or unsecure and/or unencrypted memories, or any combination thereof. The processor 1102 may also be coupled to a touchscreen display 1120, such as a resistive-sensing touchscreen, capacitive-sensing touchscreen infrared sensing touchscreen, or the like. Additionally, the smart watch 1100 may have one or more antenna 1108 for sending and receiving electromagnetic radiation that may be connected to one or more wireless data links 1112, such as one or more Bluetooth® transceivers, Peanut transceivers, Wi-Fi transceivers, ANT+ transceivers, etc., which may be coupled to the processor 1102. The smart watch 1100 may also include physical virtual buttons 1122 and 1110 for receiving user inputs as well as a slide sensor 1116 for receiving user inputs.

The touchscreen display 1120 may be coupled to a touchscreen interface module that is configured receive signals from the touchscreen display 1120 indicative of locations on the screen where a user's fingertip or a stylus is touching the surface and output to the processor 1102 information regarding the coordinates of touch events. Further, the processor 1102 may be configured with processor-executable instructions to correlate images presented on the touchscreen display 1120 with the location of touch events received from the touchscreen interface module in order to detect when a user has interacted with a graphical interface icon, such as a virtual button.

The processor 1102 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the processor 1102. The processor 1102 may include internal memory sufficient to store the application software instructions. In many devices the internal memory may be a volatile or nonvolatile memory, such as flash memory, or a mixture of both. For the purposes of this description, a general reference to memory refers to memory accessible by the processor 1102 including internal memory or removable memory plugged into the mobile device and memory within the processor 1102 itself.

The processors of the computer 800, the network computing device 900, the computing device 1000, and the smart watch 1100 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SoC 204 dedicated to wireless communication functions and one processor within an SoC 202 dedicated to running other applications. Software applications may be stored in the memory 220, 1016 before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a processor of a computing device for suggesting more efficient action sequences to a user, including recognizing a user action sequence including one or more user actions performed by the user to achieve a result, determining a first difficulty rating of the user action sequence, determining whether a cluster of multiple system action sequences exists within a cluster database, in which each system action sequence of the one or more system action sequences produces the result, comparing the first difficulty rating to one or more difficulty ratings of the one or more system action sequences in response to determining that the cluster of multiple system action sequences exists within the cluster database, and displaying, via a display interface of the computing device, one or more system action sequences with a lower difficulty rating than the first difficulty rating.

Example 2. The method of example 1, further including generating a new cluster including the user action sequence in response to determining that a cluster of multiple system action sequences that produce the result does not exist within the cluster database.

Example 3. The method of either of example 1 or 2, further including determining whether a system action sequence of the one or more system action sequences includes the one or more user actions of the user action sequence in response to determining that the cluster of multiple system action sequences exists within the cluster database, and updating the cluster database with the user action sequence in response to determining that a system action sequence of the one or more system action sequences does not include the one or more user actions of the user action sequence.

Example 4. The method of any of examples 1-3, in which comparing the first difficulty rating to one or more difficulty ratings of the one or more system action sequences includes determining whether the user action sequence has fewer actions than the one or more system action sequences, and in which displaying, via the display interface of the computing device, the one or more system action sequences with a lower difficulty rating than the first difficulty rating includes displaying the one or more system action sequences with a lower difficulty rating than the first difficulty rating in response to determining that the user action sequence has fewer actions than the one or more system action sequences.

Example 5. The method of any of examples 1-4, in which comparing the first difficulty rating to one or more difficulty ratings of the one or more system action sequences includes determining whether the user action sequence is executed slower than a time to perform any of the one or more system action sequences, and in which displaying, via the display interface of the computing device, the one or more system action sequences with a lower difficulty rating than the first difficulty rating includes displaying the one or more system action sequences with a lower difficulty rating than the first difficulty rating in response to determining that the user action sequence is executed slower than the time to perform any of the one or more system action sequences.

Example 6. The method of any of examples 1-5, further including determining whether the user action sequence has been performed a threshold number of times, in which comparing the first difficulty rating to one or more difficulty ratings of the one or more system action sequences is performed in response to determining that the user action sequence has been performed a threshold number of times.

Example 7. The method of any of examples 1-6, further including receiving a user selection indicating that the user action sequence is preferred by the user over the displayed one or more system action sequences with a lower difficulty rating, and updating the cluster database by storing the user action sequence with a lower difficulty rating than the one or more difficulty ratings of the displayed one or more system action sequences.

Example 8. The method of example 7, in which updating the cluster database by storing the user action sequence with a lower difficulty rating than the one or more difficulty ratings of the displayed one or more system action sequences includes changing the first difficulty rating to a lower difficulty rating.

Example 9. The method of example 7, in which updating the cluster database by storing the user action sequence with a lower difficulty rating than the one or more difficulty ratings of the displayed one or more system action sequences includes changing the one or more difficulty ratings of the displayed one or more system action sequences to be lower than the first difficulty rating.

Example 10. The method of any of examples 1-9, in which the user action sequence includes context and environment information associated with each action of the one or more user actions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), LTE systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a display; and
a processor coupled to the display and configured to:
recognize a user action sequence including one or more user actions performed by a user to achieve a result;
determine a first difficulty rating of the user action sequence;
determine whether a cluster of multiple system action sequences exists within a cluster database, wherein each system action sequence of the one or more system action sequences produces the result;
compare the first difficulty rating to one or more difficulty ratings of the one or more system action sequences in response to determining that the cluster of multiple system action sequences exists within the cluster database; and
display one or more system action sequences with a lower difficulty rating than the first difficulty rating.

2. The computing device of claim 1, wherein the processor is further configured to:
generate a new cluster including the user action sequence in response to determining that a cluster of multiple system action sequences that produce the result does not exist within the cluster database.

3. The computing device of claim 1, wherein the processor is further configured to:
determine whether a system action sequence of the one or more system action sequences includes the one or more user actions of the user action sequence in response to determining that the cluster of multiple system action sequences exists within the cluster database; and
update the cluster database with the user action sequence in response to determining that a system action sequence of the one or more system action sequences does not include the one or more user actions of the user action sequence.

4. The computing device of claim 1, wherein the processor is further configured to:
compare the first difficulty rating to one or more difficulty ratings of the one or more system action sequences by determining whether the user action sequence has fewer actions than the one or more system action sequences; and
display the one or more system action sequences with a lower difficulty rating than the first difficulty rating in response to determining that the user action sequence has fewer actions than the one or more system action sequences.

5. The computing device of claim 1, wherein the processor is further configured to:
compare the first difficulty rating to one or more difficulty ratings of the one or more system action sequences by determining whether the user action sequence is executed slower than a time to perform any of the one or more system action sequences; and
display the one or more system action sequences with a lower difficulty rating than the first difficulty rating in response to determining that the user action sequence is executed slower than the time to perform any of the one or more system action sequences.

6. The computing device of claim 1, wherein the processor is further configured to:
determine whether the user action sequence has been performed a threshold number of times; and
compare the first difficulty rating to one or more difficulty ratings of the one or more system action sequences in response to determining that the user action sequence has been performed a threshold number of times.

7. The computing device of claim 1, wherein the processor is further configured to:
receive a user selection indicating that the user action sequence is preferred by the user over the displayed one or more system action sequences with a lower difficulty rating; and
update the cluster database by storing the user action sequence with a lower difficulty rating than the one or more difficulty ratings of the displayed one or more system action sequences.

8. The computing device of claim 7, wherein the processor is further configured to update the cluster database by changing the first difficulty rating to a lower difficulty rating.

9. The computing device of claim 7, wherein the processor is further configured to updating the cluster database by changing the one or more difficulty ratings of the displayed one or more system action sequences to be lower than the first difficulty rating.

10. The computing device of claim 1, wherein the user action sequence includes context and environment information associated with each action of the one or more user actions.

11. A method performed by a processor of a computing device for suggesting more efficient action sequences to a user, comprising:
recognizing a user action sequence including one or more user actions performed by the user to achieve a result;
determining a first difficulty rating of the user action sequence;
determining whether a cluster of multiple system action sequences exists within a cluster database, wherein each system action sequence of the one or more system action sequences produces the result;
comparing the first difficulty rating to one or more difficulty ratings of the one or more system action sequences in response to determining that the cluster of multiple system action sequences exists within the cluster database; and
displaying, via a display interface of the computing device, one or more system action sequences with a lower difficulty rating than the first difficulty rating.

12. The method of claim 11, further comprising:
generating a new cluster including the user action sequence in response to determining that a cluster of multiple system action sequences that produce the result does not exist within the cluster database.

13. The method of claim 11, further comprising:
determining whether a system action sequence of the one or more system action sequences includes the one or more user actions of the user action sequence in response to determining that the cluster of multiple system action sequences exists within the cluster database; and
updating the cluster database with the user action sequence in response to determining that a system action sequence of the one or more system action sequences does not include the one or more user actions of the user action sequence.

14. The method of claim 11, wherein:
comparing the first difficulty rating to one or more difficulty ratings of the one or more system action sequences comprises determining whether the user action sequence has fewer actions than the one or more system action sequences; and
displaying, via the display interface of the computing device, the one or more system action sequences with a lower difficulty rating than the first difficulty rating comprises displaying the one or more system action sequences with a lower difficulty rating than the first difficulty rating in response to determining that the user action sequence has fewer actions than the one or more system action sequences.

15. The method of claim 11, wherein:
comparing the first difficulty rating to one or more difficulty ratings of the one or more system action sequences comprises determining whether the user action sequence is executed slower than a time to perform any of the one or more system action sequences; and
displaying, via the display interface of the computing device, the one or more system action sequences with a lower difficulty rating than the first difficulty rating comprises displaying the one or more system action sequences with a lower difficulty rating than the first difficulty rating in response to determining that the user action sequence is executed slower than the time to perform any of the one or more system action sequences.

16. The method of claim 11, further comprising:
determining whether the user action sequence has been performed a threshold number of times,
wherein comparing the first difficulty rating to one or more difficulty ratings of the one or more system action sequences is performed in response to determining that the user action sequence has been performed a threshold number of times.

17. The method of claim 11, further comprising:
receiving a user selection indicating that the user action sequence is preferred by the user over the displayed one or more system action sequences with a lower difficulty rating; and
updating the cluster database by storing the user action sequence with a lower difficulty rating than the one or more difficulty ratings of the displayed one or more system action sequences.

18. The method of claim 17, wherein updating the cluster database by storing the user action sequence with a lower difficulty rating than the one or more difficulty ratings of the displayed one or more system action sequences comprises changing the first difficulty rating to a lower difficulty rating.

19. The method of claim 17, wherein updating the cluster database by storing the user action sequence with a lower difficulty rating than the one or more difficulty ratings of the displayed one or more system action sequences comprises changing the one or more difficulty ratings of the displayed one or more system action sequences to be lower than the first difficulty rating.

20. The method of claim 11, wherein the user action sequence includes context and environment information associated with each action of the one or more user actions.

21. A computing device, comprising:
means for recognizing a user action sequence including one or more user actions performed by a user to achieve a result;
means for determining a first difficulty rating of the user action sequence;
means for determining whether a cluster of multiple system action sequences exists within a cluster database, wherein each system action sequence of the one or more system action sequences produces the result;
means for comparing the first difficulty rating to one or more difficulty ratings of the one or more system action sequences in response to determining that the cluster of multiple system action sequences exists within the cluster database; and
means for displaying one or more system action sequences with a lower difficulty rating than the first difficulty rating.

22. The computing device of claim 21, further comprising:
means for generating a new cluster including the user action sequence in response to determining that a cluster of multiple system action sequences that produce the result does not exist within the cluster database.

23. The computing device of claim 21, further comprising:
means for determining whether a system action sequence of the one or more system action sequences includes the one or more user actions of the user action sequence in response to determining that the cluster of multiple system action sequences exists within the cluster database; and
means for updating the cluster database with the user action sequence in response to determining that a system action sequence of the one or more system action sequences does not include the one or more user actions of the user action sequence.

24. The computing device of claim 21, wherein:
means for comparing the first difficulty rating to one or more difficulty ratings of the one or more system action sequences comprises means for determining whether the user action sequence has fewer actions than the one or more system action sequences; and
means for displaying the one or more system action sequences with a lower difficulty rating than the first difficulty rating comprises means for displaying the one or more system action sequences with a lower difficulty rating than the first difficulty rating in response to determining that the user action sequence has fewer actions than the one or more system action sequences.

25. The computing device of claim 21, wherein:
means for comparing the first difficulty rating to one or more difficulty ratings of the one or more system action sequences comprises means for determining whether the user action sequence is executed slower than a time to perform any of the one or more system action sequences; and
means for displaying the one or more system action sequences with a lower difficulty rating than the first difficulty rating comprises means for displaying the one or more system action sequences with a lower difficulty rating than the first difficulty rating in response to determining that the user action sequence is executed slower than the time to perform any of the one or more system action sequences.

26. The computing device of claim 21, further comprising:
means for determining whether the user action sequence has been performed a threshold number of times,
wherein means for comparing the first difficulty rating to one or more difficulty ratings of the one or more system action sequences comprises means for comparing the first difficulty rating to one or more difficulty ratings of the one or more system action sequences in response to determining that the user action sequence has been performed a threshold number of times.

27. The computing device of claim 21, further comprising:
means for receiving a user selection indicating that the user action sequence is preferred by the user over the displayed one or more system action sequences with a lower difficulty rating; and
means for updating the cluster database by storing the user action sequence with a lower difficulty rating than the one or more difficulty ratings of the displayed one or more system action sequences.

28. The computing device of claim 27, wherein means for updating the cluster database by storing the user action sequence with a lower difficulty rating than the one or more difficulty ratings of the displayed one or more system action sequences comprises means for changing the first difficulty rating to a lower difficulty rating.

29. The computing device of claim 27, wherein means for updating the cluster database by storing the user action sequence with a lower difficulty rating than the one or more difficulty ratings of the displayed one or more system action sequences comprises means for changing the one or more difficulty ratings of the displayed one or more system action sequences to be lower than the first difficulty rating.

30. A non-transitory processor-readable medium having stored thereon processor-executable instructions configured to cause a processor of a computing device to perform operations comprising:
recognizing a user action sequence including one or more user actions performed by a user to achieve a result;
determining a first difficulty rating of the user action sequence;
determining whether a cluster of multiple system action sequences exists within a cluster database, wherein each system action sequence of the one or more system action sequences produces the result;
comparing the first difficulty rating to one or more difficulty ratings of the one or more system action sequences in response to determining that the cluster of multiple system action sequences exists within the cluster database; and
displaying one or more system action sequences with a lower difficulty rating than the first difficulty rating.
